(19) United States
(12) Patent Application Publication
(10) Pub. No.: US 2024/0286118 A1
(43) Pub. Date: Aug. 29, 2024

(54) ELECTRIC FIELD CATALYST AND METHOD FOR REFORMING GAS USING THE SAME

(71) Applicants: Murata Manufacturing Co., Ltd., Nagaokakyo-shi (JP); Waseda University, Tokyo (JP)

(72) Inventors: Naoya MORI, Nagaokakyo-shi (JP); Yasushi SEKINE, Tokyo (JP); Kaho NAGAKAWA, Tokyo (JP)

(21) Appl. No.: 18/658,017

(22) Filed: May 8, 2024

Related U.S. Application Data
(63) Continuation of application No. PCT/JP2022/041582, filed on Nov. 8, 2022.

(30) Foreign Application Priority Data
Nov. 9, 2021 (JP) 2021-182616

(51) Int. Cl. B01J 23/755; B01J 35/33; B01J 37/10

(52) U.S. Cl. CPC B01J 23/755; B01J 35/33; B01J 37/10

(57) ABSTRACT

An electric field catalyst containing Ni, Y, Zr, and O and having a composition NiₓY_{y}Zr_{1-x-y}O₂, where 0.10≤x≤0.45 and 0.05≤ y≤0.30, a crystal structure of the electric field catalyst is free of a monoclinic crystal, Ni in a metal state and Ni in a hydroxide state are contained as the Ni, and a content A (at %) of the Ni in a metal state and a content B (at %) of the Ni in a hydroxide state with a total amount of Ni being 100 at % are such that: A>30 at %, and a ratio α of the content B to the content A is 0.15≤a≤0.63.

### CROSS REFERENCE TO RELATED APPLICATIONS

The present application is a continuation of International application No. PCT/JP2022/041582, filed Nov. 8, 2022, which claims priority to Japanese Patent Application No. 2021-182616, filed Nov. 9, 2021, the entire contents of each of which are incorporated herein by reference.

### TECHNICAL FIELD

The present description relates to an electric field catalyst and a method for reforming a gas using the same.

### BACKGROUND ART

Conventionally, as a hydrocarbon reforming catalyst, a hydrocarbon reforming catalyst containing an oxide support and Ni, a metal oxide, and an alkali metal or alkaline earth metal supported on the oxide support is known (for example, Patent Document 1).

In recent years, an electric field catalyst used by applying an electric field has been known (for example, Patent Documents 2 and 3). An electric field catalyst is attracting attention as a new catalyst because a catalytic reaction can be manifested at a lower temperature than that of a normal catalyst when the electric field catalyst is used while applying electric energy.

In Patent Document 2, as a component of the electric field catalyst, at least one selected from the group consisting of Pt, Rh, Pd, Ru, Ir, Ni, Co, CeO₂, CoO, Co₃O₄, CuO, ZnO, Mn₃O₄, BizO₃, SnO₂, Fe₂O₃, Fe₃O₄, TiO₂, Nb₂O₅, MgO, ZrO₂, La₂O₃, Sm₂O₃, Al₂O₃, SiO₂, and CaO can be contained therein.

Patent Document 3 discloses a support containing at least one of cerium oxide (ceria), zirconium oxide (zirconia), and bismuth oxide as a support of an electric field catalyst. In addition, it is disclosed that examples of an active metal include rhodium, ruthenium, platinum, iridium, palladium, and nickel, and in particular, in an electric field catalyst in a steam reforming reaction, application of rhodium and ruthenium is considered to be suitable.
Patent Document 1: JP-A-2010-155234
Patent Document 2: JP-B2-5252479
Patent Document 3: JP-B2-6444289

### SUMMARY OF THE DESCRIPTION

Since the electric field catalyst is a new technique, it cannot be said that the composition, structure, and the like are sufficiently optimized, and there is still room for improvement.

Therefore, an object of the present description is to provide an electric field catalyst having higher catalytic activity.

One gist of the present description provides: an electric field catalyst comprising Ni, Y, Zr, and O, and having a composition NiₓY_{y}Zr_{1-x-y}O₂, where 0.10≤x≤0.45 and 0.05≤y≤0.30, wherein a crystal structure of the electric field catalyst is free of a monoclinic crystal, Ni in a metal state and Ni in a hydroxide state are contained as the Ni, and a content A (at %) of the Ni in a metal state and a content B (at %) of the Ni in a hydroxide state with a total amount of the Ni being 100 at % are such that: A>30 at %, and a ratio α of the content B to the content A is 0.15≤a≤0.63.

Another gist of the present description provides: a method for reforming a gas using an electric field catalyst, the method comprising: providing an electric field catalyst that contains Ni, Y, Zr, and O and has a composition NiₓY_{y}Zr_{1-x-y}O₂, where 0.10≤x≤0.45 and 0.05≤y≤0.30, a crystal structure of the electric field catalyst is free of a monoclinic crystal, Ni in a metal state and Ni in a hydroxide state are contained as the Ni, and a content A (at %) of the Ni in a metal state and a content B (at %) of the Ni in a hydroxide state with a total amount of the Ni being 100 at % are such that: A>30 at %, and a ratio α of the content B to the content A is 0.15≤a≤0.63; and heating the electric field catalyst to a reaction temperature of 423 K to 673 K and applying an electric field to reform the gas.

The present description can provide an electric field catalyst having higher catalytic activity.

### BRIEF DESCRIPTION OF THE DRAWINGS

FIG. 1, line (a) is an XRD pattern of ZrO₂ containing Y, and lines (b) to (d) are graphs respectively showing peak positions of a tetragonal crystal, a cubic crystal, and a monoclinic crystal.

FIG. 2 is a graph illustrating a relationship between power efficiency and a ratio α.

FIG. 3 is a Ni2p photoelectron spectrum of metallic Ni, Ni hydroxide, and Ni oxide.

FIG. 4 shows a fitting result of a Ni2p photoelectron spectrum obtained by XPS measurement of a catalyst powder.

FIG. 5 schematically shows an example of a reaction device used in a method for reforming a gas using an electric field catalyst.

### DETAILED DESCRIPTION

The inventors have intensively studied to improve catalytic activity by focusing on an electric field catalyst using Ni as an active metal and yttria-stabilized zirconia as a support. As a result, the present inventors have found for the first time that the catalytic activity can be improved by preventing the support from containing monoclinic crystals, allowing Ni as the active metal to contain both Ni in a metal state and Ni in a hydroxide state, and controlling the ratio of the content of Ni in a hydroxide state to Ni in a metal state within a certain range.

Hereinafter, an electric field catalyst according to an embodiment of the present description will be described.

### First Embodiment

The electric field catalyst according to the first embodiment includes Ni, Y, Zr, and O and has a basic structure in which Ni as an active metal is supported on yttria-stabilized zirconia (Zr, Y)O₂ as an oxide support.

The composition of the electric field catalyst is represented by the chemical formula NiₓY_{y}Zr_{1-x-y}O₂, and x and y in the chemical formula respectively satisfy Formulas (1) and (2) below.

$$0.10 \leq x \leq 0 \text{.45} \qquad ( 1 )$$

$$0.05 \leq y \leq 0.30 \qquad ( 2 )$$

The reason why x and y are specified as described above is as follows.

When x is less than 0.10, the content of Ni is small, so that a catalytic reaction cannot be manifested. When x exceeds 0.45, tetragonal and cubic crystals of zirconia as a support are not stabilized, and monoclinic crystals are precipitated.

When the amount of Ni is too large (for example, x is 0.6 or more), the electric field catalyst becomes a conductor, and electricity flows through the electric field catalyst. Therefore, an electric field is not applied to the catalyst, and the power efficiency of the catalyst may be reduced.

When y is less than 0.05, the content of Y is small, tetragonal and cubic crystals of zirconia as a support are not stabilized, and monoclinic crystals are precipitated. When y exceeds 0.30, the content of Ni in the metal state decreases, and it becomes difficult for a ratio α to be described later to satisfy Formula (4).

The crystal structure of the electric field catalyst (substantially the crystal structure of the oxide support) according to the first embodiment does not contain monoclinic crystals. That is, the crystal structure is composed only of one or both of tetragonal crystals and cubic crystals.

When monoclinic crystals are contained, the catalytic activity is lowered, and therefore when monoclinic crystals are not contained, the catalytic activity of the electric field catalyst can be enhanced.

The elimination of monoclinic crystals can be achieved by controlling the content of Ni and the content of Y within appropriate ranges. That is, by adjusting the composition so that the content of Ni will satisfy Formula (1) and the content of Y will satisfy Formula (2), an electric field catalyst composed only of tetragonal and/or cubic crystals without containing monoclinic crystals can be formed.

The crystal structure is identified by powder X-ray diffraction.

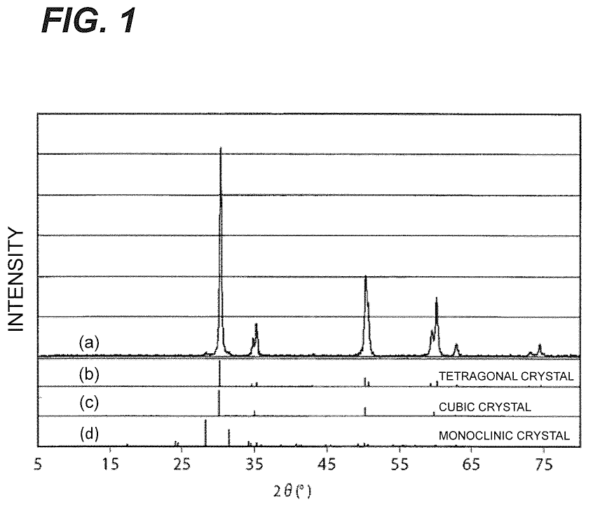

FIG. 1 shows a typical XRD pattern ((a) for ZrO₂ containing Y and peak positions of each crystal structure in (b) to (d)). The XRD pattern of FIG. 1 line (a) is measured using CuKα radiation. When a peak in the vicinity of 2θ=28° ((−111) plane) and a peak in the vicinity of 2θ=32° ((111) plane), which remarkably show the presence of monoclinic crystals, are present in the XRD pattern of the electric field catalyst, it is determined that monoclinic crystals are present.

The electric field catalyst according to the first embodiment contains Ni in a metal state (hereinafter sometimes referred to as “metallic Ni”) and Ni in a hydroxide state (hereinafter sometimes referred to as “Ni hydroxide”) as Ni, and the contents thereof satisfy the following conditions.

With regard to a content A (at %) of Ni in a metal state and a content B (at %) of Ni in a hydroxide state when the total amount of Ni is 100 at %,
the content A satisfies Formula (3) below, and
the ratio α of the content B to the content A satisfies Formula (4) below.

$$A \geq 30 at \% \qquad ( 3 )$$

$$0.15 \leq α \leq 0.63 \qquad ( 4 )$$

The inventors have found for the first time that the catalytic activity can be improved by containing a part of Ni in the electric field catalyst in the form of Ni hydroxide. As a result of further studies on the appropriate content of Ni hydroxide, it has been found that the ratio α of the content of Ni hydroxide to the content of metallic Ni has a certain correlation with the catalytic activity.

By satisfying Formulas (3) and (4) above, the catalytic activity of the electric field catalyst can be enhanced. In particular, high catalytic activity can be achieved even at low reaction temperatures (for example, 573 K or lower).

The reason why the catalytic activity can be improved by the presence of Ni hydroxide is not clear, but a reaction mechanism has been proposed in which protons adsorbed on the catalyst surface affect the activity in an electric field catalytic reaction, and it is presumed that the hydroxy group (—OH) of Ni hydroxide, in which a proton and oxygen are bonded, promotes the reaction of the electric field catalyst.

The ratio α preferably satisfies Formula (5) below. This makes it possible to further enhance the catalytic activity.

$$0.25 \leq α \leq 0.45 \qquad ( 5 )$$

The content A of metallic Ni when the total amount of Ni is 100 at % is preferably 35 at % or more. In other words, the content A preferably satisfies Formula (6) below.

$$A \geq 35 at \% \qquad ( 6 )$$

The catalytic activity can be determined by power efficiency. The power efficiency is an index obtained by dividing the enthalpy of reaction formation ΔᵣH (Js⁻¹) by the input power EP (Js⁻¹) and is defined by Formula (7) below.

$$Power efficiency ( \% ) = {Δ}_{r} H ( {Js}^{- 1} ) / EP ( {Js}^{- 1} ) \times 100 ( \% ) \qquad ( 7 )$$

When the power efficiency is 9% or more, it can be evaluated that the catalyst has high catalytic activity, when the power efficiency is 12% or more, it can be evaluated that the catalyst has higher catalytic activity, and when the power efficiency is 15% or more, it can be evaluated that the catalyst has extremely high catalytic activity.

As described later, in a preferable method for producing an electric field catalyst according to the first embodiment, pretreatment with a pretreatment gas containing hydrogen (H₂) is performed. The electric field catalyst is more preferably pretreated with a pretreatment gas further containing water vapor (H₂O) in addition to hydrogen (H₂), and extremely high catalytic activity can thus be achieved.

From the results of examples described later, it has been confirmed that the catalytic activity is remarkably improved by performing pretreatment with a pretreatment gas containing H₂ and H₂O as compared with an electric field catalyst pretreated with a pretreatment gas containing H₂ but not containing H₂O. However, as described below, the change in the electric field catalyst depending on whether the pretreatment gas contains H₂O cannot be confirmed with any physical property value (such as the ratio α).

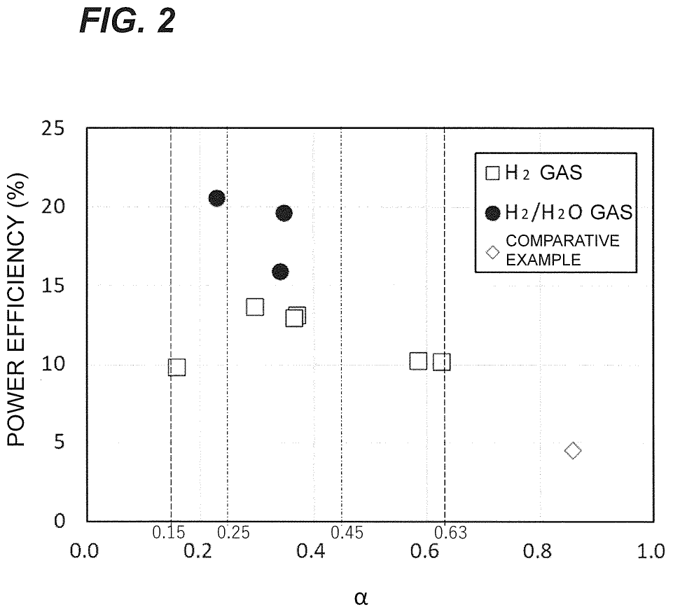

FIG. 2 is a graph showing a relationship between power efficiency as an index of catalytic activity and the ratio α of the content of Ni hydroxide to the content of metallic Ni. The result of the electric field catalyst pretreated with the pretreatment gas containing hydrogen (H₂) but not containing water vapor (H₂O) is plotted with □, and the result of the electric field catalyst pretreated with the pretreatment gas containing hydrogen (H₂) and water vapor (H₂O) is plotted with

In the case of the electric field catalyst pretreated with the pretreatment gas containing hydrogen (H₂) but not containing water vapor (H₂O), the power efficiency is low when the ratio α is less than 0.15 or more than 0.63, and the power efficiency is significantly improved to 9% or more when the ratio α is in the range of 0.15 to 0.63. In the range of 0.25 to 0.45, the power efficiency is further improved to 12% or more (in FIG. 2).

On the other hand, in the electric field catalyst pretreated with the pretreatment gas containing hydrogen (H₂) and water vapor (H₂O), the power efficiency shows a high value of 15% or more in the range of 0.15 to 0.63 (□ in FIG. 2). However, even at similar ratios α, different power efficiencies may be exhibited (in Examples 9 and 10 to be described later, the ratios α are both about 0.34, but the power efficiencies are greatly different and are about 20% and about 16%, respectively).

In the present description, it has been found that the catalytic activity of the electric field catalyst using the active metal Ni is enhanced by controlling the ratio α of the content of the Ni hydroxide to the content of the metallic Ni, and as can be seen from FIG. 2, the electric field catalyst according to the first embodiment can be said to have high catalytic activity when the ratio α is in the range of 0.15 to 0.63. However, it is difficult to explain the fact that the electric field catalyst exhibits higher catalytic activity when pretreated with a pretreatment gas containing hydrogen (H₂) and water vapor (H₂O) in relation to the ratio α, and although other physical property values were examined, no physical property value showing the correlation with the effect of improving the catalytic activity has been found.

Therefore, in the present specification, an electric field catalyst pretreated with a pretreatment gas containing hydrogen and water vapor is defined by performing pretreatment using the pretreatment gas, instead of being defined by physical properties.

Ni in the catalyst can be in an oxide state (hereinafter sometimes referred to as “Ni oxide”) other than the metal state (metallic Ni) and the hydroxide state (Ni hydroxide). The state of Ni in the catalyst (metal state, hydroxide state, and oxide state) can be identified by X-ray photoelectron spectroscopy (XPS). Hereinafter, an identification method by XPS will be described in detail.

A catalyst powder subjected to the necessary pretreatment is transferred into a glove box with an Ar atmosphere without being exposed to the atmosphere, pressed against an In foil to be fixed to provide a sample for XPS measurement.

The sample is fixed to a sample stage for a carbon coater (Gatan, Inc., PECS) with double-sided tape, and a conductive carbon film having a thickness of 1.5 nm is vapor-deposited on a surface of the sample with the carbon coater. Since the sample is exposed to the atmosphere when taken out from the glove box and transferred to the carbon coater, the exposure time is set to 5 minutes or less in order to suppress a change in the state of the sample surface due to exposure to the atmosphere.

The sample taken out from the carbon coater is fixed on an alumina plate with carbon tape, and the plate with the sample is fixed on a sample stage of XPS and introduced into an ultra-high vacuum XPS apparatus. Since the sample is exposed to the atmosphere when transferred from the carbon coater to the XPS apparatus, the exposure time is set to 5 minutes or less in order to suppress a change in the state of the sample surface due to exposure to the atmosphere.

As the XPS apparatus, for example, PHI Quantes manufactured by ULVAC-PHI, Inc. can be used. The X-ray beam is a monochromatic Al-Kα radiation (output: 100 W, 20 kV), and the beam size is 100 μm in diameter.

With a pass energy of 26.0 eV, an energy step of 0.1 eV, and a residence time per step of 100 ms, an inner shell photoelectron spectrum is measured in the binding energy range and the number of sweeps shown in Table 1. In order to compensate for charging of the sample surface at the time of photoelectron spectrum measurement, an electron beam is applied at an acceleration voltage of 30 V and an emission current of 20 μA simultaneously with an Art ion beam at an acceleration voltage of 10 V and an emission current of 5 mA.

TABLE 1

| Target element/ | Setting of minimum | Setting of number |
|---|---|---|
| orbital | binding energy range | of sweeps |
| C1s | 278 to 295 eV | Twice or more |
| O1s | 525 to 538 eV | Twice or more |
| Ni2p | 846 to 893 eV | 12 times or more |
| Zr3d | 175 to 190 eV | Twice or more |
| Y3d | 148 to 163 eV | 8 times or more |

In the obtained Ni2p photoelectron spectrum, the ratio of Ni (metallic Ni) in a metal state, Ni (Ni hydroxide) in a hydroxide state, and Ni (Ni oxide) in an oxide state is quantified by the following procedure.

The energy correction value of the charge shift is determined so that the peak indicating C—C bond observed in the C Is photoelectron spectrum will be 285 eV, and this value is applied to the Ni2p photoelectron spectrum to correct the charge shift. Next, in order to remove the background, the end points on the low binding energy side and the high binding energy side of the baseline are varied in the ranges of 848 to 850 eV and 888 to 902 eV, respectively, and the positions of the intersection points between the end points of the baseline and the Ni2p photoelectron spectrum are adjusted to be near the center of the noise of the Ni2p photoelectron spectrum. After these adjustments, the background of the photoelectron spectrum is removed by the Interated Shirley method.

The Ni2p photoelectron spectra obtained from the standard substances of a metal foil of metallic Ni, a powder of Ni hydroxide, and a powder of Ni oxide are used as references of metallic Ni, Ni hydroxide, and Ni oxide, respectively, and are linearly combined to perform fitting by the least squares method on the Ni2p photoelectron spectrum after data processing obtained as described above.

The Ni2p photoelectron spectra of the standard substances are acquired under the same measurement conditions as those of the measurement sample, and the data processing is also the same. However, in the case of the metal foil of Ni metal, the oxide layer is removed by Ar⁺ ion sputtering before the measurement, and then XPS measurement is performed, and charge shift correction is performed so that the binding energy value of the peak of Ni2p 3/2 indicating the metal state will be 852.7 eV.

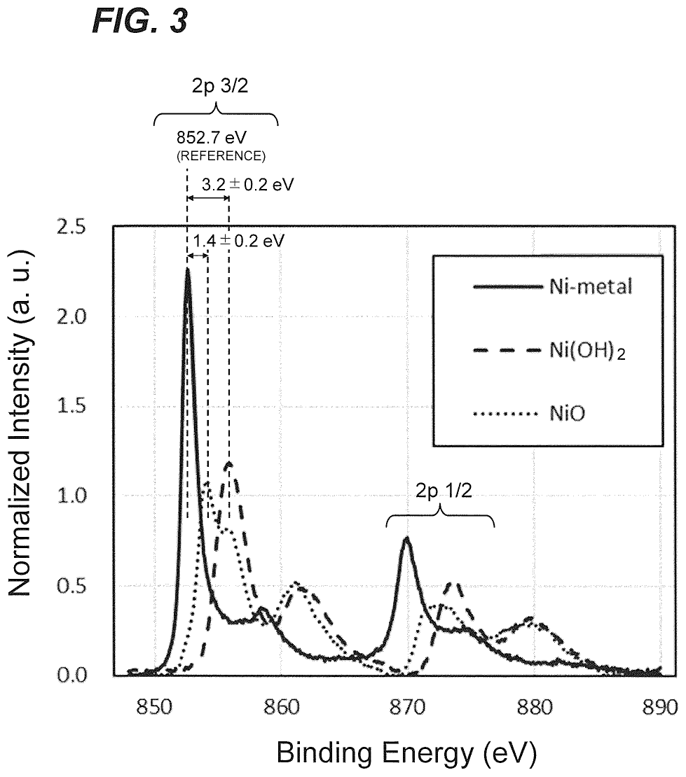

In the fitting by the least squares method, the shift of the reference Ni2p photoelectron spectrum of each of metallic Ni, Ni hydroxide, and Ni oxide is allowed in consideration of an error in charge shift correction of the Ni2p photoelectron spectrum of the sample and a difference in charge magnitude between the chemical states. FIG. 3 shows the respective reference Ni2p photoelectron spectra of metallic Ni (Ni-metal), Ni hydroxide (Ni(OH)₂), and Ni oxide (NiO). No restriction is imposed on the shift of the spectrum of metallic Ni, and the Ni2p photoelectron spectra of Ni hydroxide and Ni oxide are restricted such that the relative binding energy differences from the Ni2p photoelectron spectrum of metallic Ni are 1.4+0.2 eV and 3.2+0.2 eV, respectively (FIG. 3). The shift of the Ni2p photoelectron spectrum during fitting is changed in 0.025 eV steps.

In the fitting by the least squares method, the coefficient by which the intensity of the Ni2p photoelectron spectrum of each reference is multiplied is changed so that the sum of squares of fitting errors at each energy point of 849 to 887 eV will be minimized.

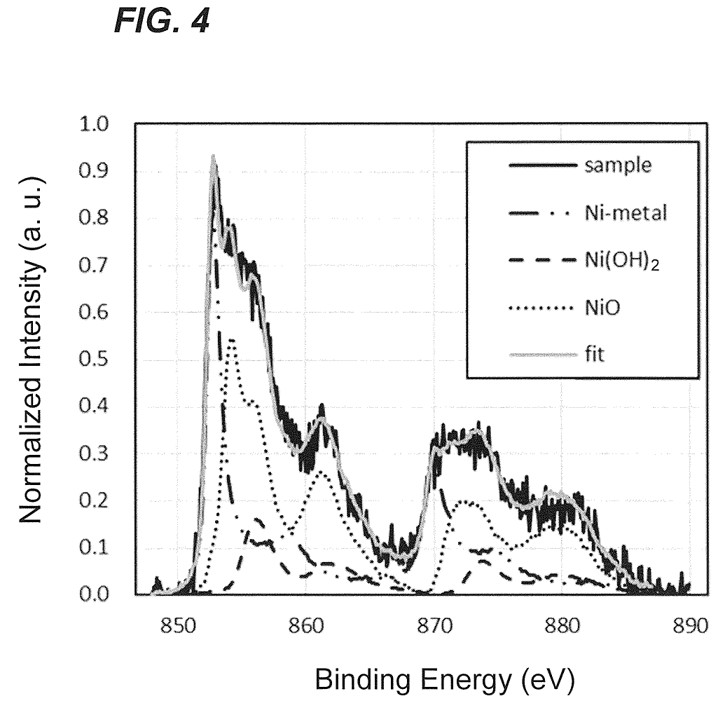

After fitting, the area intensities of the Ni2p photoelectron spectra of metallic Ni, Ni hydroxide, and Ni oxide in the above range are determined, and the ratio thereof is calculated as a chemical state ratio. An illustrative example of the fitting results is shown in FIG. 4. FIG. 4 shows a measured Ni2p photoelectron spectrum (sample) of the catalyst powder, a reference Ni2p photoelectron spectrum of each of metallic Ni (Ni-metal), Ni hydroxide (Ni(OH)₂), and Ni oxide (NiO), and a fitting curve (fit) created by the above method.

In the inner shell photoelectron spectrum obtained by XPS measurement, C 1s was excluded, the area intensity was calculated, and sensitivity correction was performed to determine the atomic concentration of the element. An energy point at which the tail of the peak of the inner shell photoelectron spectrum is sufficiently lowered is set as an end point of the baseline, the background is defined by the iterated Shirley method, and the area intensities of the respective elements in the inner shell photoelectron spectrum are calculated. These are divided by the relative sensitivity correction coefficient to calculate the atomic concentration. This arithmetic processing is performed by analysis software MultiPak manufactured by ULVAC-PHI, Inc., and a value incorporated in the same software is used as the relative sensitivity coefficient.

### (Production Method)

The method for producing the electric field catalyst of the first embodiment is not particularly limited, but since an electric field catalyst having the above physical properties can be produced with good reproducibility, the following production method can be adopted.

A person skilled in the art who has come across the disclosure of the present application may arrive at a different method by which the electric field catalyst of the first embodiment can be produced on the basis of the disclosure.

The electric field catalyst can be produced by the polymerized complex method, the solid phase method, or the like.

Hereinafter, a production method by the polymerized complex method will be described as an example.

Nitrates of zirconium, yttrium, and nickel are weighed so as to have a predetermined composition ratio and dissolved in a solution obtained by dissolving ethylene glycol and citric acid in distilled water. The solution is heated at an appropriate heating temperature for an appropriate heating time while being stirred with an evaporator, and after heating, the solution is evaporated to dryness with a hot stirrer. The appropriate heating temperature and the appropriate heating time can be appropriately set depending on the raw material to be used and the amount of the raw material to be charged at the time of production. As an example, the heating temperature is 323 K to 363 K (for example, 343 K), and the heating time is 12 hours to 48 hours (for example, 24 hours).

Thereafter, calcination is performed at an appropriate calcination temperature for an appropriate calcination time. The appropriate calcination temperature and the appropriate calcination time can be appropriately set depending on the type and amount of the material to be calcined. As an example, the calcination temperature is 573 K to 873 K (for example, 673 K), and the calcination time is 1 hour to 12 hours (for example, 2 hours).

Thereafter, main firing is performed at an appropriate firing temperature and an appropriate firing time to obtain a catalyst powder. The appropriate firing temperature and the appropriate firing time can be appropriately set depending on the type and amount of the material to be fired. As an example, the firing temperature is 1,073 K to 1,473 K (for example, 1,173 K), and the firing time is 1 hour to 24 hours (for example, 10 hours).

The obtained catalyst powder is pretreated with a pretreatment gas containing hydrogen (H₂) in a powder state, a molded state, or a granulated powder state pulverized after molding. By using the pretreatment gas containing hydrogen (H₂), Ni contained in the catalyst powder is partially reduced to Ni in a metal state (metallic Ni). The pretreatment gas preferably contains hydrogen (H₂) and water vapor (H₂O).

In addition to hydrogen (H₂), the pretreatment gas may contain Ar gas, N₂ gas, He gas, or the like as an inert gas. In addition, the pretreatment gas may contain methane, propane, or the like as a reducing gas together with hydrogen or in place of hydrogen.

The pretreatment is performed, for example, at a pretreatment temperature of 673 K to 1,273 K for 0.5 hours to 5 hours. The flow rate of the pretreatment gas is controlled to an appropriate flow rate according to the composition of the pretreatment gas and the amount of the catalyst powder to be pretreated.

The pretreatment can be carried out in a suitable heating furnace or in a reactor for gas reforming with a catalyst. In the case of performing the pretreatment in the reactor, the catalyst is filled in a predetermined position of the reactor, and then the catalyst is heated while flowing the pretreatment gas into the reactor.

In this way, the electric field catalyst according to the first embodiment can be obtained.

### Second Embodiment

A second embodiment is a method for reforming a gas using the electric field catalyst according to the first embodiment.

The reforming method of the second embodiment includes the steps of: 1) preparing an electric field catalyst; and 2) reforming.

### Step 1) Step of Preparing Electric Field Catalyst

This step is a step of preparing the electric field catalyst according to the first embodiment.

The step of preparing the electric field catalyst may include, for example, a step of mixing raw materials, a step of sintering, and a step of treating the obtained sintered powder with a pretreatment gas.

Since the prepared electric field catalyst and the preparation step thereof are as described in the first embodiment, the description thereof is omitted.

### Step 2) Reforming Step

The electric field catalyst is heated to a reaction temperature of 423 K to 673 K, and an electric field is further applied. The gas to be reformed (such as a hydrocarbon) is brought into contact with the electric field catalyst in that state to react (reform) the gas.

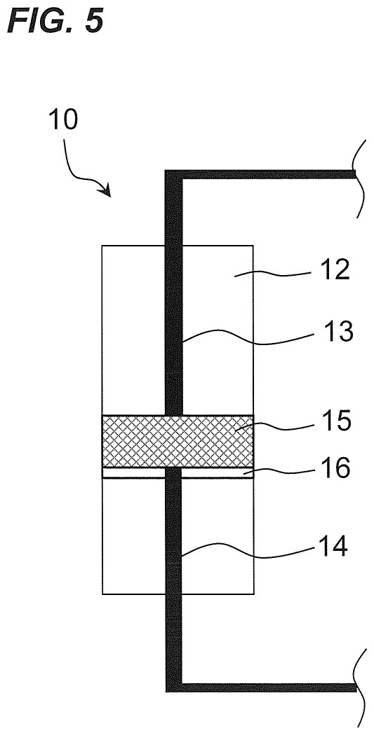

The reforming step can be performed using, for example, a normal-pressure fixed-bed flow reactor equipped with an electrode. FIG. 5 shows an example of a normal-pressure fixed-bed flow reactor (reaction device) 10 including a pair of electrodes 13 and 14. The normal-pressure fixed-bed flow reactor (reaction device) 10 includes a support 16 for supporting a catalyst 15 inside a reaction vessel 12, and the catalyst 15 is disposed on the support 16. The pair of electrodes 13 and 14 are in direct contact with the catalyst 15. When the reforming step is performed, a voltage is applied between the pair of electrodes 13 and 14 to apply an electric field to the catalyst 15.

The amount of the catalyst 15 to be used is not particularly limited and is appropriately adjusted according to the reaction device 10 to be used and the type and supply amount of the gas to be reformed. In addition, the catalyst 15 may be filled in the reaction vessel 12 in a powder state or may be disposed in the reaction vessel 12 after being molded in a disk shape in advance, or a granulated catalyst powder pulverized and granulated after molding may be used.

### EXAMPLE 1

### (Production of Catalyst Powder for Measurement)

Nitrates of zirconium, yttrium, and nickel were weighed so as to have a composition ratio shown in Table 2 and dissolved in a solution obtained by dissolving ethylene glycol and citric acid in distilled water. The solution was heated at a retention temperature of 343 K for 24 hours while being stirred with an evaporator, and after heating, the solution was evaporated to dryness with a hot stirrer. After calcination at a retention temperature of 673 K for a retention time of 2 hours, main firing was performed at a retention temperature of 1,173 K and a retention time of 10 hours to obtain a catalyst powder for measurement.

### (Crystal Structure)

Powder XRD measurement of the obtained catalyst powder was performed to determine the crystal structure. The XRD measurement was performed using CuKα radiation at an output of 50 (kV) and 30 (mA).

From the XRD pattern, the presence or absence of monoclinic crystals (peaks at 20=28° and 32°) was determined.

When peaks can be observed at positions of 20=28° and 32° in the XRD pattern, it is determined that monoclinic crystals were contained, and when peaks cannot be observed, it is determined that monoclinic crystals were not contained. The results are shown in Table 2.

### (State of Ni)

The state of Ni (metal state, hydroxide state, and oxide state) was determined by XPS analysis, and the content (at %) of Ni atoms in each state was measured.

### (Activity Evaluation)

The obtained catalyst powder was filled in a mold, pressurized with a press at 60 kN for 10 minutes, and molded into a disk shape. This molded sample was ground in a mortar and classified to 355 to 500 μm using a sieve. Activity evaluation was performed using the classified granulated catalyst powder. The activity evaluation was performed using a normal-pressure fixed-bed flow reactor.

A quartz tube having an outer diameter of 8.0 mm and an inner diameter of 6.0 mm was used as a reaction tube, and 80 mg of the classified granulated catalyst powder was filled therein. Electrodes having an outer diameter of 2 mm were inserted from above and below the reaction tube and brought into contact with the catalyst.

As pretreatment, a pretreatment gas was passed at H₂: Ar=1:1 and a total flow rate of 120 CCM, and reduction treatment was performed at a furnace temperature of 873 K and a retention time of 1 hour.

Subsequently, a reaction gas was passed to perform a catalytic reaction. The reaction conditions were as follows.
Reaction gas flow rate: 120 CCM
Reaction gas composition: CH₄: H₂O: Ar=1:2:7
Applied current: 9 mA
Reaction temperature (furnace temperature): 473 K

The gas composition after the reaction was analyzed by gas chromatography. The results of the gas composition determined here were used in obtaining “ΔᵣH (Js⁻¹)” defined by Formula (8) in the “Power Efficiency” section described below.

The reaction formula of the reaction gas is as follows.

$$C {H}_{4} + {H}_{2} O \to C O + 3 {H}_{2}$$

$$CO + {H}_{2} O \to {CO}_{2} + 4 {H}_{2}$$

### (Power Efficiency)

In order to examine the efficiency of the electric field catalyst, the power efficiency was determined. The power efficiency results are shown in Table 2.

The power efficiency is an index obtained by dividing the enthalpy of reaction formation ΔᵣH (Js⁻¹) by the input power EP (Js⁻¹) and is defined by Formula (7) below.

$$Power efficiency ( \% ) = {Δ}_{r} H ( {Js}^{- 1} ) / EP ( {Js}^{- 1} ) \times 100 ( \% ) \qquad ( 7 )$$

Here, the enthalpy of reaction formation ΔᵣH (Js⁻¹) is an enthalpy of reaction formation obtained on the basis of the reaction formula of the reaction gas described above and is defined by Formula (8) below.

$${Δ}_{r} H = {r}_{CO} \times {ΔH}_{CO} + {r}_{CO 2} \times Δ {H}_{CO 2} - {r}_{CO} \times Δ {H}_{CH 4} - ( {r}_{CO} + 2 {r}_{CO 2} ) \times Δ {H}_{H 2 O} \qquad ( 8 )$$

Here, ΔH_{CO}, ΔH_{CO2}, ΔH_{CH4}, and ΔH_{H2O} are enthalpy values (KJ/mol) of CO, CO₂, CH₄, and H₂O, respectively, and are constants unique to the respective chemical substances.

The expressions r_{CO} and r_{CO2} are the formation rates (mol/sec) of CO and CO₂, respectively, and are determined from the results of the activity evaluation test.

The input power EP is obtained by multiplying the current I and the voltage V according to Formula (9) below.

$$EP ( {Js}^{- 1} ) = I ( mA ) \times V ( kV ) \qquad ( 9 )$$

The measurement results are shown in Table 2. In Table 2, underlined numerical values indicate that they are out of the scope of the present description. In Comparative Examples 1 to 4, since monoclinic crystals were observed, XPS measurement was not performed. Therefore, in Table 2, a line (-) is recorded in the cells of “Ni” of Comparative Examples 1 to 3 and 6.

TABLE 2

| | | | | Presence or | Ni | | | | |
|---|---|---|---|---|---|---|---|---|---|
| | Composition | | | absence of | Metallic Ni | Ni hydroxide | | | Power |
| Measurement | Ni | Y | Zr | monoclinic | (A) | (B) | Ni oxide | α | efficiency |
| sample | x | y | 1 − x − y | crystals | (at %) | | | (B/A) | (%) |
| Comparative | 0.30 | 0.01 | 0.69 | Present | — | — | — | — | 5.5 |
| Example 1 | | | | | | | | | |
| Comparative | 0.30 | 0.03 | 0.67 | Present | — | — | — | — | 5.9 |
| Example 2 | | | | | | | | | |
| Comparative | 0.30 | 0.04 | 0.66 | Present | — | — | — | — | 6.8 |
| Example 3 | | | | | | | | | |
| Example 1 | 0.30 | 0.05 | 0.65 | Absent | 60.2 | 18.0 | 21.8 | 0.299 | 13.6 |
| Example 2 | 0.30 | 0.10 | 0.60 | Absent | 36.0 | 13.4 | 50.6 | 0.372 | 13.1 |
| Example 3 | 0.30 | 0.30 | 0.40 | Absent | 32.6 | 19.1 | 48.3 | 0.586 | 10.2 |
| Comparative | 0.30 | 0.40 | 0.30 | Absent | 26.8 | 23.0 | 50.2 | 0.858 | 4.5 |
| Example 4 | | | | | | | | | |
| Comparative | 0.05 | 0.10 | 0.85 | Absent | 22.0 | 20.0 | 58.0 | 0.909 | — |
| Example 5 | | | | | | | | | |
| Example 4 | 0.10 | 0.10 | 0.80 | Absent | 43.9 | 27.5 | 28.6 | 0.626 | 10.1 |
| Example 5 | 0.40 | 0.10 | 0.50 | Absent | 35.8 | 13.1 | 51.1 | 0.366 | 12.9 |
| Example 6 | 0.45 | 0.10 | 0.45 | Absent | 53.5 | 8.5 | 38.0 | 0.159 | 9.8 |
| Comparative | 0.50 | 0.10 | 0.40 | Present | — | — | — | — | — |
| Example 6 | | | | | | | | | |

* Composition: NiₓY_{y}Zr_{1-x-y}O₂

The results in Table 2 are discussed.

In Comparative Examples 1 to 3, since the content (y) of Y was less than the lower limit of the appropriate range, tetragonal and cubic crystals were not stabilized, and monoclinic crystals were precipitated. Therefore, the power efficiency was low.

In Comparative Example 4, since the content (y) of Y was larger than the upper limit of the appropriate range, the proportion of metallic Ni was low, a deviated from the appropriate range, and the power efficiency was also low.

In Comparative Example 5, the content of Ni was small, and the catalytic reaction did not appear.

In Comparative Example 6, the content of Ni was large, and zirconia could not be stabilized. Therefore, tetragonal and cubic crystals were not stabilized, and monoclinic crystals were precipitated.

In Examples 1 and 2, at Ni=0.30, Y=0.05 and 0.10, respectively, and 0.25<a<0.40, so that the power efficiency was high.

In Example 3, Ni=0.30 and Y=0.30, and the content of metallic Ni was a little low and the content of Ni hydroxide was a little high, so that a tended to increase. The power efficiency was sufficiently high but lower than in Examples 1 and 2.

In Example 4, Ni=0.10 and Y=0.10, and the content of metallic Ni was high and the content of Ni hydroxide was a little high, so that a tended to increase. Therefore, the power efficiency was sufficiently high but lower than in Examples 1 and 2.

In Example 5, Ni=0.40 and Y=0.10, and 0.25<a<0.40, so that the power efficiency was high.

In Example 6, Ni=0.45 and Y=0.10, and the content of metallic Ni was a little high and the content of Ni hydroxide was a little low, so that the ratio α tended to decrease. The power efficiency was sufficiently high but lower than in Examples 1 and 2.

### EXAMPLE 2

The effect when the electric field catalyst was pretreated with a pretreatment gas containing hydrogen (H₂) and water vapor (H₂O) was examined.

### (Production of Catalyst Powder for Measurement)

Nitrates of zirconium, yttrium, and nickel were weighed so as to have the composition ratio shown in Table 3, and a catalyst powder for measurement was obtained in the same procedure as in [Example 1].

### (Crystal Structure)

Powder XRD measurement of the obtained catalyst powder was performed to determine the crystal structure. The measurement conditions and the determination method were the same as in [Example 1].

### (State of Ni)

The state of Ni (metal state, hydroxide state, and oxide state) was determined by

XPS analysis, and the content (at %) of Ni atoms in each state was measured. The measurement conditions and the determination method were the same as in [Example 1].

### (Activity Evaluation)

Evaluation was performed in the same manner as in [Example 1] except that a gas having a composition shown in Table 3 was used as the pretreatment gas.

The measurement results are shown in Table 3.

TABLE 3

| | | | | | | | Presence or | Ni | | | | |
|---|---|---|---|---|---|---|---|---|---|---|---|---|
| | Pretreatment gas | | | Composition | | | absence of | Metallic Ni | Ni hydroxide | | | Power |
| Measurement | H₂ | H₂O | Ar | Ni | Y | Zr | monoclinic | (A) | (B) | Ni oxide | α | efficiency |
| sample | (CCM) | | | x | y | 1 − x − y | crystals | (at %) | | | (B/A) | (%) |
| Example 1 | 50 | 0 | 50 | 0.30 | 0.05 | 0.65 | Absent | 60.2 | 18.0 | 21.8 | 0.299 | 13.6 |
| Example 8 | 25 | 25 | 50 | 0.30 | 0.05 | 0.65 | Absent | 57.9 | 13.3 | 28.8 | 0.230 | 20.6 |
| Example 9 | 10 | 40 | 50 | 0.30 | 0.05 | 0.65 | Absent | 54.2 | 18.8 | 27.0 | 0.347 | 19.6 |
| Example 10 | 40 | 10 | 50 | 0.30 | 0.05 | 0.65 | Absent | 55.8 | 19.0 | 25.2 | 0.341 | 15.9 |

* Composition: NiₓY_{y}Zr_{1-x-y}O₂

In Examples 8 to 10, in the catalyst material having the composition of x=0.30 and y=0.05, by adding water vapor (H₂O) together with H₂ as the pretreatment gas, the power efficiency was increased as compared with Example 1 (without addition of water vapor). The ratio α in Examples 8 to 10 was in the range of 0.20 to 0.40.

### EXPLANATION OF REFERENCES

10 Normal-pressure fixed-bed flow reactor (reaction device)
12 Reaction vessel
13, 14 Pair of electrodes
15 Catalyst
16 Supporting means

1. An electric field catalyst comprising:
Ni, Y, Zr, and O, and having a composition NiₓY_{y}Zr_{1-x-y}O₂,
where 0.10≤x≤0.45 and 0.05≤y≤0.30,
wherein a crystal structure of the electric field catalyst is free of a monoclinic crystal,
Ni in a metal state and Ni in a hydroxide state are contained as the Ni, and
a content A (at %) of the Ni in a metal state and a content B (at %) of the Ni in a hydroxide state with a total amount of Ni being 100 at % are such that:
A>30 at %, and
a ratio α of the content B to the content A is 0.15≤a≤0.63.

2. The electric field catalyst according to claim 1, wherein the ratio α is 0.25≤a≤0.45.

3. The electric field catalyst according to claim 1, wherein the ratio α is 0.20≤a≤0.40.

4. The electric field catalyst according to claim 1, wherein A≥35 at %.

5. A method for reforming a gas using an electric field catalyst, the method comprising:
providing an electric field catalyst that contains Ni, Y, Zr, and O and has a composition NiₓY_{y}Zr_{1-x-y}O₂, where 0.10≤x≤0.45 and 0.05≤y≤0.30, a crystal structure of the electric field catalyst is free of a monoclinic crystal, Ni in a metal state and Ni in a hydroxide state are contained as the Ni, and a content A (at %) of the Ni in a metal state and a content B (at %) of the Ni in a hydroxide state with a total amount of the Ni being 100 at % are such that: A>30 at %, and a ratio α of the content B to the content A is 0.15≤a≤0.63; and
heating the electric field catalyst to a reaction temperature of 423 K to 673 K and applying an electric field to reform the gas.

6. The method for reforming a gas according to claim 5, further comprising pretreating the electric field catalyst with a pretreatment gas containing hydrogen.

7. The method for reforming a gas according to claim 6, wherein the pretreating is performed at a pretreatment temperature of 673 K to 1,273 K for 0.5 hours to 5 hours.

8. The method for reforming a gas according to claim 5, further comprising pretreating the electric field catalyst with a pretreatment gas containing hydrogen and water.

9. The method for reforming a gas according to claim 8, wherein the pretreating is performed at a pretreatment temperature of 673 K to 1,273 K for 0.5 hours to 5 hours.

10. The method for reforming a gas according to claim 5, wherein the ratio α is 0.25≤a≤0.45.

11. The method for reforming a gas according to claim 5, wherein the ratio α is 0.20≤a≤0.40.

12. The method for reforming a gas according to claim 5, wherein A>35 at %.
